(19) United States
(12) Patent Application Publication
(10) Pub. No.: US 2004/0248759 A1
(43) Pub. Date: Dec. 9, 2004

(54) Composition and method for modifying the soil release properties of a surface

(76) Inventors: Kim R. Smith, Woodbury, MN (US); Keith E. Olson, Apple Valley, MN (US); Victor F. Man, Saint Paul, MN (US); Bryan Michael Anderson, Saint Paul, MN (US)

Correspondence Address: David R. Cleveland, IPLM Group, P.A., P.O. Box 18455, Minneapolis, MN, 55418, US

(21) Appl. No.: 10/153,826

(22) Filed: May 22, 2002

(51) Int. Cl. C11D 1/00

(52) U.S. Cl. 510/466; 510/505; 510/506

(57) ABSTRACT

The soil release properties of a surface are modified by applying to the surface a treatment composition comprising a mixture of hydroxyether and polyalkoxysilane. The treatment can discourage water spotting and soil accumulation, and can make the surface easier to clean and maintain.

### TECHNICAL FIELD

This invention relates to surfaces. The invention also relates to methods for imparting soil resistance to surfaces.

### BACKGROUND

Many compositions have been proposed for cleaning or coating hard surfaces. Despite many years of effort by various researchers, it can still be difficult to clean hard surfaces and, once cleaned, to maintain the appearance of the cleaned surface in a satisfactory state.

### SUMMARY OF INVENTION

The present invention provides, in one aspect, a surface treatment composition comprising a mixture of hydroxyether and polyalkoxysilane. In a preferred embodiment, the composition comprises a surface-reactive, alkoxy-containing adduct of hydroxyether and dialkoxy- or trialkoxysilane.

In another aspect, the invention provides a method for treating a surface comprising applying thereto a mixture of hydroxyether and polyalkoxysilane, optionally rinsing away excess mixture, and allowing the surface to dry. In a preferred embodiment, the surface to be treated has a plurality of available hydroxyl, amine or amide groups and the mixture comprises a surface-reactive, alkoxy-containing adduct of hydroxyether and dialkoxy- or trialkoxysilane.

In a further aspect, the invention provides a soil-releasing treated surface having bound thereto an adduct of hydroxyether and polyalkoxysilane.

In yet a further aspect, the invention provides a kit containing the above-described surface treatment composition, a detergent for cleaning the surface, an applicator for applying the composition to a surface, a removal agent for restoring a surface treated with the composition to its original untreated condition, and instructions for use of the kit.

### BRIEF DESCRIPTION OF THE DRAWING

FIG. 1 is a graph of oil contact angle vs. water contact angle.

FIGS. 2a through 2e are side views of neighboring drops of water and oil on various treated surfaces.

### DETAILED DESCRIPTION

As used in the present invention, the term “adduct of a hydroxyether and a polyalkoxysiloxane” refers to the reaction product that is believed to form when a hydroxyether and a polyalkoxysilane are mixed at room temperature and allowed to stand for a time sufficient to permit hydrolysis of at least one of the alkoxy groups on the polyalkoxysiloxane to take place. The term “adduct of a hydroxyether and a polyalkoxysiloxane” will also be deemed to refer to any composition whose chemical formula would be that same as that of such a reaction product even if the composition was not formed by mixing a hydroxyether and a polyalkoxysilane.

The surface treatments of the invention can provide durable soil release properties on a variety of hard surfaces. Preferably such soil release properties will persist through several rinsing and wash cycles without requiring reapplication after each wash. For example, when applied to the ceramic tile walls of a shower stall or to a glass shower door, preferred treatments of the invention may prevent or discourage soap scum formation and water spotting through many days, weeks or months of use. This can reduce the work required to clean such surfaces and can reduce the required cleaning frequency.

A variety of hydroxyethers can be employed in the invention. Preferred hydroxyethers are hydroxyalkylethers having the formula:

AY_{X} (1)

where:

A is hydrogen or a C₁-C₂₄ linear or branched, saturated or unsaturated alkyl, aralkyl, or aryl group that optionally may contain O, N, S, or P heteroatoms or halogen atoms,

Y is —[(OCH₂CH₂)ₘ(O(R₆)CHCH₂)ₙOH] where m and n are not both zero and independently may be 0 to 100,000, preferably 0 to 1000, and most preferably 1 to 50; R₆ can be hydrogen or a C₁-C₂₄ alkyl group and preferably is hydrogen or methyl; and Y may contain halogen (e.g., fluorine) atoms.

X is a number from 1 to 4, preferably 1 to 2.

Salts of the hydroxyether may be employed if desired. Nonlimiting examples of suitable hydroxyethers include polyoxyethylenes; polyoxypropylenes; ethylene oxide/alkylene oxide copolymers (e.g., ethylene oxide/propylene oxide copolymers); alkyl glycol ethers; alcohol ethoxylates, propoxylates and ethoxylate-propoxylates; alkylphenol ethoxylates, propoxylates and ethoxylate-propoxylates; hydroxy alkyl cellulose (e.g., hydroxy propyl cellulose); and mixtures and salts (e.g., quaternary ammonium compounds containing ethoxy or propoxy groups) thereof. Suitable commercially available polyoxyethylenes include CARBOWAX™ PEG-200, PEG-400, PEG-8000 and PEG-100,000 polyethylene glycols from Dow Chemical Company. Suitable commercially available polyoxypropylenes include P and PT™ series polypropylene glycols such as PPG-10, PPG-500, PPG-6000, and PPG-90,000 polypropylene glycols from Dow Chemical. Suitable commercially available ethylene oxide/alkylene oxide copolymers include PLURONIC™ L101, PLURONIC™ 25R2, PLURAFAC™ LF-221, TETRONIC™ 1102 and TETRONIC™ 90R4 copolymers from BASF, and SURFONIC™ LDO-97 copolymer from Huntsman Chemical. Suitable glycol ethers include propylene glycol methyl ether, dipropylene glycol methyl ether, tripropylene glycol methyl ether, propylene glycol phenyl ether, propylene glycol butyl ether, ethylene glycol n-butyl ether, ethylene glycol sec-butyl ether, ethylene glycol tert-butyl ether, diethylene glycol butyl ether, triethylene glycol butyl ether, ethylene glycol phenyl ether, and ethylene glycol nonylphenol ether. Suitable alcohol ethoxylates include linear ethoxylates such as SURFONIC™ 24-1.3, SURFONIC™ 24-7 and SURFONIC™ 46-9 ethoxylates from Huntsman and nonlinear ethoxylates such as TERGITOL™ 25-S-7 and TERGITOL™ 25-S-9 ethoxylates from Dow Chemical Company. Suitable alcohol ethoxylate-propoxylates include laureth-7 EO-1 PO (where “EO” signifies ethylene oxide and “PO” signifies propylene oxide). Suitable alkylphenol ethoxylates include octylphenol-5 EO and nonylphenol-9 EO. Suitable alkylphenol propoxylates include hexylphenol-12 PO and dodecylphenol-2 PO. Suitable alkylphenol ethoxylate-propoxylates include nonylphenol-2 EO-2 PO. Other suitable alkoxylate hydroxyethers include myristeth-10 EO-2 BO and deceth-1 PO-20 EO-DO. Suitable hydroxy alkyl celluloses include KLUCEL™ E and KLUCEL™ M cellulosic thickeners from Hercules Incorporated. Suitable alkoxylated quaternary ammonium salts include tetradecylmethyldi(polyethoxy)ammonium chloride, methyl(polyethoxy)morpholine, ethoxylated ether amine quaternary ammonium salts, didecylmethyl(polyethoxy)ammonium bromide, trimethyl(polyethoxy)ammonium sulfate, octyltri(polyethoxy)ammonium acetate, and diethylmethyl(polypropoxy)ammonium chloride.

A variety of polyalkoxysilanes can be used in the invention. Particularly preferred polyalkoxysilanes are dialkoxy- or trialkoxysilanes having the formulae:

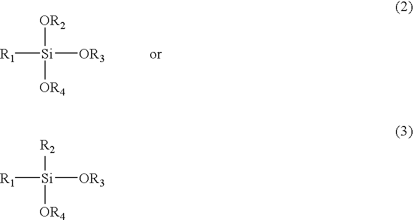

where:

R₁ is a C₁-C₂₄ linear or branched, saturated or unsaturated alkyl, aralkyl, or aryl group that optionally may contain O, N, S, or P heteroatoms or halogen atoms,

R₂, R₃, and R₄ can be independently selected from C₁-C₂₄ linear or branched, saturated or unsaturated alkyl, aralkyl, or aryl groups.

Preferably, R₁, R₂, R₃, and R₄ are independently selected from C₁-C₁₀ alkyl groups. Optionally any or all of R₁, R₂, R₃ and R₄ can contain halogen (e.g., fluorine) atoms. Nonlimiting examples of the polyalkoxysilane include octyltriethoxysilane, vinyldimethoxysilane, isobutyltrimethoxysilane, 3-aminopropyltriethoxysilane, 3-methyacryloxypropyltrimethoxysilane, methylaminopropyltrimethoxysilane, 3-glycidoxypropyltrimethoxysilane, cyclohexylmethyldimethoxysilane, diphenyldimethoxysilane, isobutylisopropyldimethoxysilane, hexadecyldiethoxysilane, and 3-mercaptopropyltrimethoxysilane and mixtures thereof. Triethoxymethylsilane and diethoxydimethylsilane are particularly preferred polyalkoxysilanes.

The compositions of the invention are conveniently prepared by combining the hydroxyether and polyalkoxysilane in the absence of water. If water is excluded the mixture typically will not undergo hydrolysis, and preferably will have an indefinite shelf life when so stored.

The compositions of the invention can also be prepared by combining the hydroxyether and polyalkoxysilane with water or other suitable solvent and storing the resulting mixture. The hydroxyether and polyalkoxysiloxane can be combined in either order. In some instances more effective treatment results may be obtained for such mixtures if the polyalkoxysilane is added to the hydroxyether. Acid or base can be added to accelerate or retard the hydrolysis reaction. Hydrolysis can be accelerated by stirring the mixture. The progress of hydrolysis can be monitored using, for example, infrared absorption analysis. Preferably the mixture is used relatively promptly. If allowed to stand for too long (usually about one or two days), the silane may oligomerize, typically indicated by the formation of a precipitate or cloudiness and a loss of effectiveness as a service treatment.

The surface to be treated preferably is cleaned using cleaning agents or solvents that will be familiar to those skilled in the art. The compositions of the invention can be applied as substantially anhydrous concentrates or as dilute solutions, e.g., as aqueous solutions. The composition of the invention preferably is applied directly to the surface to be treated using a suitable applicator (e.g., a brush, spray, roller or squeegee) and allowed to stand for sufficient time (e.g., one minute or more) to enable hydrolysis of at least one of the alkoxy groups on the polyalkoxysilane and formation of a durably-bonded surface treatment to take place. The required standing time may vary depending on factors such as the temperature of the surface or of the composition, the nature of the surface and its cleanliness, and other factors that will be apparent to those skilled in the art. If desired, the hydroxyether and polyalkoxysiloxane can be individually applied to the surface. Following treatment, the surface can optionally be rinsed to remove excess treatment agent and dried using measures that will be familiar to those skilled in the art. Heat or a stream of air can be used to accelerate drying.

Without intending to be bound by theory, the hydroxyether and polyalkoxysilane are believed to react with one another and then with an available reactive group on the surface. For example, when a hydroxyether of the formula ROH and diethoxydimethylsilane are combined with one another and then applied to a surface containing reactive hydroxyl groups, the following reactions may take place:

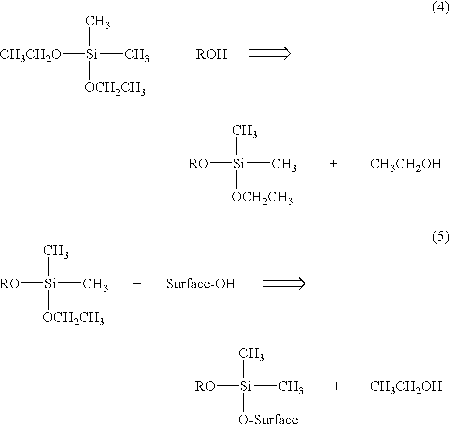

The adduct formed in reaction (4) is believed to form a covalent bond at many points on the surface in reaction (5).

The hydroxyether and polyalkoxysilane can be combined in a variety of ratios. Preferably, the compositions of the invention contain hydroxyether and polyalkoxysilane in a hydroxyether/polyalkoxysilane molar ratio between about 1/100 and about 100/1, more preferably between about 1/20 and about 20/1, yet more preferably between about 1/5 and about 5/1, and most preferably between about 1/2 and about 2/1. If diluted, the concentration of the adduct (or the total concentration of the hydroxyether and polyalkoxysilane) can be between about 0.1 and about 99 wt. % active ingredients, more preferably between about 2 and about 30 wt. % active ingredients, and most preferably between about 3 and about 20 wt. % active ingredients. The concentrate or dilute solution may be in the form of a solid which is dissolved or dispersed in a carrier solvent prior to application, or in a variety of other convenient forms such as a gel, paste, liquid, foam or aerosol.

The compositions of the invention affect the water and oil contact angles exhibited by the treated surface. In some instances it may be desirable to reduce or to increase one or both of the water contact angle or oil contact angle. For example, the water contact angle can be significantly reduced or the oil contact angle can be significantly increased. In general it will be preferred to reduce both the oil and water contact angles. Also, it will be preferred to select the nature and type of treatment based on the ratio of oil contact angle to water contact angle for the treated surface. Preferably the ratio of oil contact angle to water contact angle for the treated surface is at least 0.8. Yet more preferably, the ratio of oil contact angle to water contact angle is at least 1. Most preferably, the ratio of oil contact angle to water contact angle is at least 2.3. When the ratio of oil contact angle to water contact angle is sufficiently high, water tends to form a sheet on the treated surface, oil tends to form beads on the treated surface, and the water sheet tends to ride underneath and lift away the oil beads. This phenomenon can be observed by placing a water droplet and oil droplet side-by-side on the treated surface and observing the behavior of the droplets under magnification when they contact one another.

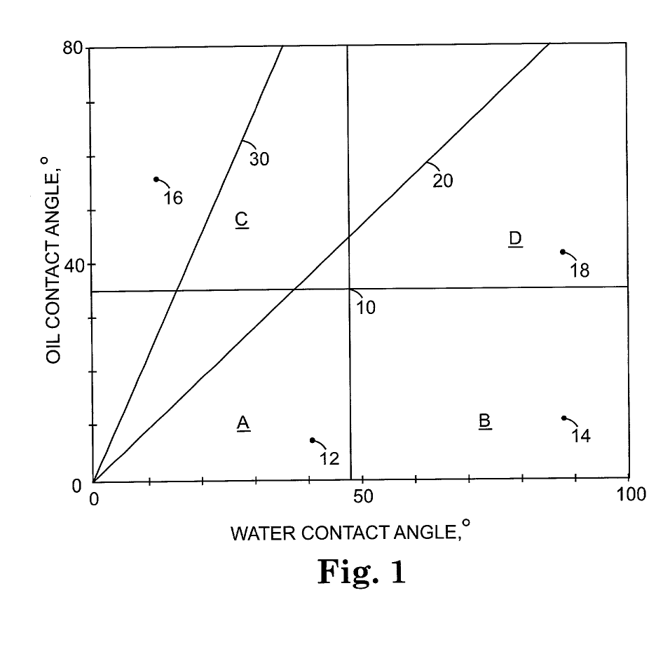

FIG. 1 is a graph of oil contact angle vs. water contact angle. Water contact angle is shown on the horizontal axis, and ranges between 0 and 100°. Oil contact angle is shown on the vertical axis, and ranges between 0 and 80°. The area of the graph has been divided into four zones A through D. The zones intersect at point 10, corresponding to the oil and water contact angles exhibited by an untreated ceramic tile. Within zone A, water and oil contact angles are less than those exhibited by the untreated tile. Water and oil both have a tendency to form sheets. For a surface whose behavior is like that indicated by point 12, water spotting is reduced but dried soil may be tightly bound. Within zone B, water contact angles are greater and oil contact angles are less than those exhibited by the untreated tile. Water has a tendency to form beads and oil has a tendency to form sheets. For a surface whose behavior is like that indicated by point 14, water spotting is likely and dried soil may be tightly bound. Within zone C, water contact angles are less and oil contact angles are greater than those exhibited by the untreated tile. Water has a tendency to form sheets and oil has a tendency to form beads. For a surface whose behavior is like that indicated by point 16, the oil contact angle is significantly greater than the water contact angle, and water tends to form a sheet and can underride and lift away oils. Water spotting is reduced and soil may be loosely bound, thus facilitating cleaning and the maintenance of a clean surface. Within zone D, water and oil contact angles are greater than those exhibited by the untreated tile. Water and oil both have a tendency to form beads. For a surface whose behavior is like that indicated by point 18, dried soil may be loosely bound but water spotting is likely.

Treated surfaces whose oil and water contact angles lie above and to the left of line 20 in FIG. 1 have a ratio of oil contact angle to water contact angle greater than 1, and exhibit preferred surface properties. Treated surfaces whose oil and water contact angles lie above and to the left of line 30 in FIG. 1 have a ratio of oil contact angle to water contact angle greater than 2.3, and exhibit particularly preferred surface properties.

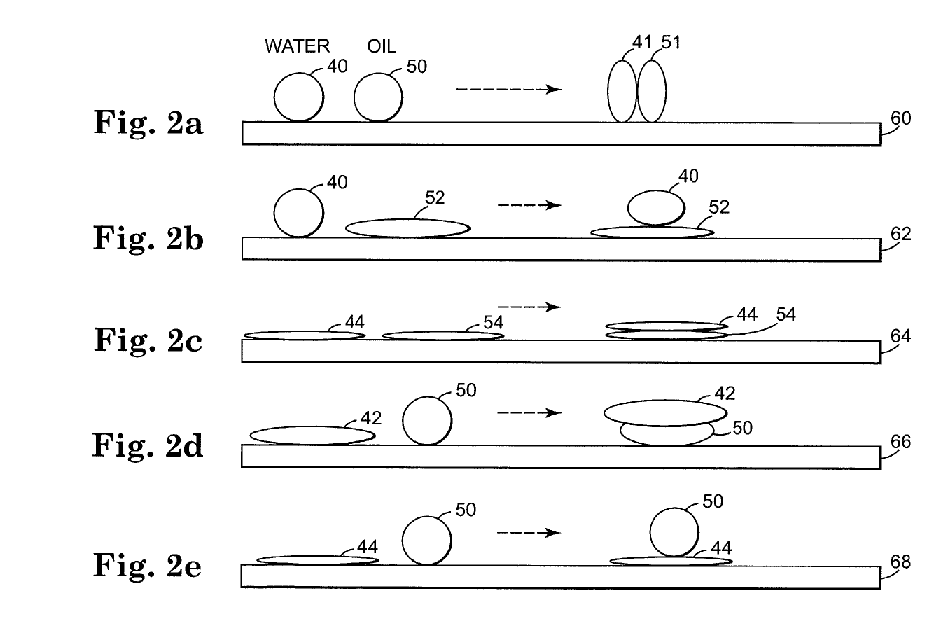

FIGS. 2a through 2e are side views of neighboring drops of water and oil on various treated surfaces. In FIG. 2a, water drop 40 and oil drop 50 on surface 60 are allowed to approach one another. At equilibrium, they tend to form side-by-side high contact angle drops 41 and 51. In FIG. 2b, water drop 40 and low contact angle oil drop 52 on surface 62 are allowed to approach one another. At equilibrium, water drop 40 tends to lie atop oil drop 52. In FIG. 2c, water sheet 44 and oil sheet 54 are placed on surface 64 and allowed to approach one another. At equilibrium, water sheet 44 tends to lie atop oil sheet 54. In FIG. 2d, low contact angle water drop 42 and oil drop 50 are placed on surface 66 and allowed to approach one another. At equilibrium, water drop 42 tends to lie atop oil drop 50. In FIG. 2e, water sheet 44 and oil drop 50 are placed on surface 68 and allowed to approach one another. At equilibrium, oil drop 50 tends to lie atop water sheet 44. This facilitates the cleaning of and soil release by surface 68, and assists in maintaining surface 68 in a clean condition.

The compositions of the invention can be applied to a wide variety of materials including glass, fiberglass, ceramic tile, concrete, natural stone (e.g., sandstone), masonry (e.g., bricks or mortar), gypsum, metal, cotton, paper, aluminum, painted surfaces and polymeric materials (e.g., polyurethanes, polyureas and polyvinyl alcohols). The compositions of the invention have particular utility for application on surfaces containing hydroxyl or primary or secondary amine or amide groups. Depending on the nature of the substrate to be treated, it may be preferred to use different hydroxyethers or different polyalkoxysilanes in the treatment composition. For example, a mixture of alkylene polyethoxy polyalkoxy ether and diethoxydimethyl silane is preferred for use on glass or fiberglass; a mixture of a polyethoxy polypropoxy copolymer and diethoxydimethyl silane is preferred for use on ceramic; and a mixture of a fluorinated alkylpolyethoxylate and diethoxydimethyl silane is preferred for use on concrete.

The compositions of the invention and the treated surfaces are stable over a relatively wide range of pH values, e.g., between about 3 and about 14. If desired, the soil release treatment can be removed from the treated surface by exposing the treated surface to acidic conditions at a suitably low pH, e.g., at or below pH 3. Those skilled in the art or recognize that a variety of techniques can be employed to bring about such acidic conditions. One convenient method is by spraying or soaking the treated surface with a phosphoric acid solution. Another convenient method is by spraying or soaking the treated surface with a solution of an acidic salt, especially hydrogen sulfate or hydrogen phosphate salts. Yet another convenient method is by spraying or soaking the treated surface with a solution of an acidic gas, especially carbon dioxide.

The compositions of the invention have a wide variety of uses. Representative uses include soil release treatments for architectural surfaces including showers, interior and exterior floors, interior and exterior walls, windows, sidewalks, bridges, culverts, wash bays (e.g., car wash facilities) and drains; protective treatments for fabrics; protective treatments for transportation vehicles including cars, trucks, boats, railroad cars and planes, especially for problem areas such as windshields, rubberized trim, hulls, aluminum rails, etc.; soil release or “clean in place” treatments for food, beverage and other process equipment; protective treatments for water handling (e.g., process water) systems; protective treatments to control or limit biofilm formation; and antistatic treatments. The compositions of the invention can permit the use of milder and safer detergents and other cleaning agents, and can reduce the intensity and frequency of required cleaning activities.

The compositions of the invention can be packaged as kits containing the soil release treatment (typically packaged into components containing, for example, the hydroxyether and the polyalkoxysilane or a premixed combination thereof), a suitable applicator, a suitably mild and safe detergent for cleaning the treated surface, a removal agent for restoring the treated surface to its original untreated condition, and suitable instructions.

The invention is further illustrated in the following non-limiting examples, in which all parts and percentages are by weight unless otherwise indicated.

### EXAMPLE 1

### Effect of Hydroxyether/Polyalkoxysilane Treatment on Wetting of Ceramic Tile

Conventional ceramic tiles were treated with an equimolar mixture of hydroxyether and polyalkoxysilane, water rinsed, and then dried with a paper towel. The contact angles of both deionized water and light mineral oil on the treated tile were measured using a Model 100-00 goniometer (Rame-Hart) and are shown below in Table 1.

TABLE 1

| | | | Water | Oil |
|---|---|---|---|---|
| | | | Contact | Contact |
| Run No. | Hydroxyether | Polyalkoxysilane | Angle, ° | Angle, ° |
| 1-1 | None | None | 47 | 37 |
| 1-2 | None | Dimethyldiethoxysilane | 42 | 30 |
| 1-3 | polyethoxy | None | 49 | 35 |
| | polypropoxy | | | |
| | copolymer¹ | | | |
| 1-4 | polyethoxy | Dimethyldiethoxysilane | 30 | 18 |
| | polypropoxy | | | |
| | copolymer¹ | | | |

¹LDO-97 (Huntsman Chemical)

The data in Table 1 shows that the hydroxyether/polyalkoxysilane mixture of Run No. 1-1 altered the contact angles of water and oil (which affect water spotting and soil release respectively) to a much greater extent than that obtained using hydroxyether alone or polyalkoxysilane alone.

### EXAMPLE 2

### Resistance of Treated Surface to Water

A ceramic tile was treated with the mixture of Run 1-1, water rinsed, and then dried with a paper towel. The contact angles of deionized water on the treated tile were measured and recorded. The tile was submerged in water for an extended period of time. Periodically the tile was removed, dried, and the water and oil contact angles remeasured. The results are set out below in Table 2.

TABLE 2

| | | Water Contact |
|---|---|---|
| Run No. | Time, hrs. | Angle, ° |
| 2-1 | 0 | 10 |
| 2-2 | 1 | 10 |
| 2-3 | 4 | 13 |
| 2-4 | 8 | 10 |
| 2-5 | 24 | 11 |
| 2-6 | 168 | 14 |

As shown in Table 2, the soil release treatment was unaffected by full immersion in water for at least one week (168 hours).

### EXAMPLE 3

### Removal of Soil Release Treatment by Change in pH

A ceramic tile was treated with the mixture of Run No. 1-1, water rinsed, and then dried with a paper towel. The contact angles of deionized water on the treated tile were measured. The treated tiles were exposed to rinse solutions having varying pH values, immediately rinsed with water, dried with a paper towel and the water contact angles remeasured. The results are set out below in Table 3.

TABLE 3

| | | Water | Water |
|---|---|---|---|
| | | Contact | Contact |
| | | Angle | Angle |
| | Rinse | Before | After |
| Run No. | pH | Rinse, ° | Rinse, ° |
| 3-1 | 14 | 15 | 13 |
| 3-2 | 10 | 15 | 17 |
| 3-3 | 7 | 16 | 20 |
| 3-4 | 3 | 14 | 19 |
| 3-5 | 1 | 16 | 29 |

The data in Table 3 shows that the water contact angle of the treated surface was not substantially affected by exposure to alkaline rinse solutions down to about pH 3. Below pH 3 the rinse solution appears to have removed the treatment.

### EXAMPLE 4

### Effect of Concentration of Hydroxyether/Polyalkoxysilane Treatment

Ceramic tiles were treated with undiluted or 1% aqueous solutions of the hydroxyether/polyalkoxysilane mixture of Run No. 1-4. Using the method of Example 1, the contact angles of deionized water and light mineral oil on the treated tiles were measured. The results are shown below in Table 4.

TABLE 4

| | | Water | Oil |
|---|---|---|---|
| | Concentration, | Contact | Contact |
| Run No. | wt. % of | Angle, ° | Angle, ° |
| 4-1 | 1 | 13 | 15 |
| 4-2 | 100 | 10 | 15 |

As shown in Table 4, the concentration of the soil release treatment did not have a significant impact on the ability of the treatment to modify the water and oil contact angles on the tile substrate.

### EXAMPLE 5

### Effect of Molar Ratio of Hydroxyether/Polyalkoxysilane

Ceramic tiles were treated with mixtures of the hydroxyether of Example 1 and two polyalkoxysilanes (diethoxydimethylsilane or triethoxymethylsilane), at various molar ratios. Using the method of Example 1, the contact angles of deionized water and light mineral oil on the treated tiles were measured. The results are shown below in Table 5.

TABLE 5

| | | Hydroxyether/ | Water | Oil |
|---|---|---|---|---|
| Run | | Polyalkoxysilane | Contact | Contact |
| No. | Polyalkoxysilane | Molar Ratio | Angle, ° | Angle, ° |
| 5-1 | Diethoxydimethylsilane | 1/1 | 13 | 15 |
| 5-2 | Diethoxydimethylsilane | 1/2 | 17 | 21 |
| 5-3 | Diethoxydimethylsilane | 2/1 | 10 | 17 |
| 5-4 | Triethoxymethylsilane | 1/1 | 21 | 19 |
| 5-5 | Triethoxymethylsilane | 1/2 | 9 | 18 |
| 5-6 | Triethoxymethylsilane | 2/1 | 6 | 18 |

As shown in Table 5, a wide molar ratio range of hydroxyether/polyalkoxysilane mixtures provides significant oil and water contact angle reduction.

### EXAMPLE 6

### Evaluation of a Variety of Hydroxyethers

Ceramic tiles were treated with various equimolar hydroxyether/polyalkoxysilane compositions, water rinsed, and dried with a paper towel. Unless otherwise noted, the polyalkoxysilane was diethoxydimethylsilane. Using the method of Example 1, the contact angles of deionized water and light mineral oil on the treated tiles were measured. The results are set out below in Table 6.

TABLE 6

| | | Water | Oil |
|---|---|---|---|
| | | Contact | Contact |
| Run No. | Hydroxyether | Angle, ° | Angle, ° |
| 6-1 | None | 47 | 37 |
| 6-2 | ethylene glycol | 36 | 11 |
| 6-3 | propylene glycol | 47 | 13 |
| 6-4 | hexylene glycol | 16 | 37 |
| 6-5 | Ethylene glycol n-butyl ether | 16 | 7 |
| 6-6 | methyldiethylpolypropoxyammonium | 43 | 7 |
| | chloride | | |
| 6-7 | Nonylphenol-9.5 EO | 17 | 13 |
| 6-8 | C₁₂ tripolyethoxyammonium | 18 | 27 |
| | chloride | | |
| 6-9 | alkylene polyethoxy polyalkoxy | 6 | 57 |
| | ether¹ | | |
| 6-10 | 50:50 blend of polyethoxy | 39 | 9 |
| | polypropoxy copolymer² and 2- | | |
| | propanol, titanium(4+) salt³ | | |
| 6-11⁴ | 50:50 blend of polyethoxy | 22 | 10 |
| | polypropoxy copolymer² and 2- | | |
| | propanol, titanium(4+) salt³ | | |
| 6-12 | Fluorinated alkylpolyethoxylate⁵ | 5 | 45 |

¹LF-221 (BASF)
²LDO-97 (Huntsman Chemical)
³TYZOR ™ TPT (DuPont)
⁴Dimethyldiethoxysilane was used as the polyalkoxysilane
⁵ZONYL ™ FSO (DuPont)

As shown in Table 6, all the treatments affected the wetting characteristics (and hence the soil release and water spotting characteristics) of the tiles.

### EXAMPLE 7

### Release of Oily Soil from a Surface

A ceramic tile was treated with a 10% solution of the treatment solution of Run No. 6-9, water rinsed, and dried with a paper towel. A drop of mineral oil was placed on the tile and drops of water were slowly added next to the oil drop. As the water on the tile came into contact with the oil, it moved underneath the oil and lifted it from the tile surface. When this experiment was repeated using an untreated ceramic tile, the water was unable to move underneath the oil drop or lift it from the tile surface.

### EXAMPLE 8

### Improved Appearance of Soiled Surface Prior to Cleaning

A ceramic tile was sprayed with a 10% aqueous solution of the treatment solution of Run No. 5-1, water rinsed, and dried with a paper towel. This treated tile and an untreated tile were then sprayed with equal amounts of a soil mixture containing calcium soap and mineral oil as its primary components. Visually, the tile treated with the soil release composition appeared to be cleaner than the untreated one even though neither had been cleaned. Microscopic examination showed that the soil mixture had “beaded-up” on the treated tile and only covered 76% of the surface area. In contrast, the soil mixture covered 98% of the untreated tile.

### EXAMPLE 9

### Evaluation of Hydroxyether/Polyalkoxysilane Soil Release Treatment on a Vehicle

An equimolar mixture of diethylmethylpolypropoxyammonium chloride and diethoxydimethylsilane was sprayed as a 10% aqueous solution onto various surfaces of a delivery truck followed by a water rinse. The treated surfaces included a mudflap, tire, and aluminum rail. Water tended to form a sheet on the treated surfaces. This behavior is contrary to the water bead formation normally thought to be desirable on a freshly cleaned and waxed vehicle. After two weeks without washing, the appearance of the truck was evaluated. The treated areas had a less severe soil build-up and a better appearance than comparable untreated areas of the truck.

### EXAMPLE 10

### Evaluation of Hydroxyether/Polyalkoxysilane Soil Release Treatment in Shower Stalls

The treatment solution of Run No. 5-1 was applied to three tiles in a heavily used shower at a site whose water is roughly 18 grains in hardness. The treatment solution was allowed to stay on the tiles for approximately 10 minutes after which the excess coating was removed using a fresh water rinse. The treated tiles exhibited a beneficial sheeting action that prevented water from remaining on the tile surface. On the nearby untreated tiles, water tended to form beads rather than sheeting. After several weeks the untreated tiles exhibited appreciable soap scum and mineral deposit residues from the hard water, and continued to cause water beading. The treated tiles were substantially free of soap scum and mineral deposits, and continued to cause water sheeting. The treated and untreated tiles were cleaned once per month using a relatively acidic cleaner for hard water conditions (HWTM Bathroom Cleaner, Ecolab). The cleaner removed all the soap scum and mineral deposits from both the treated and untreated tiles. After three such cleaning cycles the treated tiles still caused water to sheet and did not appear to accumulate soils nearly as quickly as the untreated tiles. However, at the fourth and fifth months, the soil repellency performance of the treatment declined. The decline is believed to have been caused by removal of the treatment by the acidic cleaner. Use of a less acidic cleaner (or even plain water) should provide longer-lasting soil repellency performance.

In a separate run, a mixture of 5 parts LF-221 alkylene polyethoxy polyalkoxy ether and 1 part diethoxydimethylsilane was applied to a freshly-cleaned fiberglass shower stall at a lake cabin whose water is roughly 12 grains in hardness. The treatment solution was allowed to stay on the surface for approximately 5 minutes, followed by removal of the excess treatment solution using a fresh water rinse. The treated surface exhibited a beneficial water sheeting action. The shower was used on weekends over a one month time span, using only a water rinse for cleaning. The shower stall remained clean and spot-free, with no soap scum or mineral accumulation, and with no deterioration in its shiny appearance at the time of treatment. Prior to the treatment, the shower stall had required frequent cleaning using a relatively harsh detergent cleanser, and even a single use of the shower was enough to cause a noticeable deterioration in its appearance.

### EXAMPLE 11

### Glass Treatment

A windowpane was divided into upper and lower halves using a strip of masking tape. The upper half was further divided into two quarters using an additional strip of masking tape. The upper right-hand quarter portion was treated with an equimolar mixture of LF-221 alkylene polyethoxy polyalkoxy ether and dimethyldiethoxysilane followed by a water rinse and air drying. The treated portion had a clear and streak-free appearance. The lower half of the windowpane was left untreated. A 10% mixture of dirt in well water was sprayed on the window and allowed to air dry. The entire window was then cleaned with a tap water rinse and allowed to air dry. This sequence of soiling and rinsing was repeated four additional times after which a visual comparison was made of the treated and untreated areas. The treated portion remained clear and streak-free following exposure, whereas the untreated lower portion of the windowpane was covered with a translucent hazy film and water spots.

### EXAMPLE 12

### Evaluation of a Variety of Treatments

Using the method of Example 1, a variety of reactive materials were added to diethoxydimethylsilane, then applied to ceramic tiles, water rinsed, and dried with a paper towel. Except where otherwise noted, equimolar amounts of the reactant and diethoxydimethylsilane were employed. The water and oil contact angles of the treated tiles were evaluated using the method of Example 1. Several of the treated tiles were evaluated using the method of Example 7 to determine whether a water drop would move underneath an oil drop and lift the oil drop from the treated surface. A variety of comparison materials were also evaluated. Set out below in Table 12 are the Example No. or Comparative Example No., reactive material (“Reactant”), water and oil contact angles, ratio of the oil contact angle to the water contact angle, and further information regarding the identity of the reactant where known.

TABLE 12

| | | | | Oil/Water | | |
|---|---|---|---|---|---|---|
| | | Water | Oil | Contact | | |
| Example No. or | Reactant(s) added to | Contact | Contact | Angle | Water | |
| Comp. Ex. No. | diethoxydimethylsilane | Angle, ° | Angle, ° | Ratio | lifts oil? | Reactant Description |
| 12-1 | Alcohol ethoxylate 24-1.3 | 42 | 18 | 0.4 | | Alcohol ethoxylate |
| 12-2 | Alcohol ethoxylate 24-3 | 64 | 27 | 0.4 | | Alcohol ethoxylate |
| 12-3 | Alcohol ethoxylate 24-5 | 44 | 21 | 0.5 | | Alcohol ethoxylate |
| 12-4 | Alcohol ethoxylate 24-7 | 44 | 14 | 0.3 | no | Alcohol ethoxylate |
| 12-5 | Alcohol ethoxylate 45-13 | 13 | 18 | 1.4 | | Alcohol ethoxylate |
| 12-6 | Alcohol ethoxylate 91-2.5 | 54 | 23 | 0.4 | | Alcohol ethoxylate |
| 12-7 | Alcohol ethoxylate 91-6 | 60 | 29 | 0.5 | | Alcohol ethoxylate |
| 12-8 | BUTYL CELLOSOLVE ™ | 16 | 7 | 0.4 | | Ethylene glycol n-butyl ether |
| 12-9 | DOWANOL ™ PPh | 18 | 15 | 0.8 | | Phenol-1 PO |
| 12-10 | Ethylene glycol | 36 | 11 | 0.3 | | |
| 12-11 | GLENSURF ™ Glen | 43 | 7 | 0.2 | | Propoxylated quat |
| | Chemicals) | | | | | |
| 12-12 | Glycerol | 19 | 31 | 1.6 | | |
| 12-13 | Hexylene glycol | 16 | 37 | 2.3 | no | |
| 12-14 | KLUCEL ™ E (Hercules Inc.); | 32 | 15 | 0.5 | | Cellulosic thickener |
| | 10 mol % polyalkoxysilane | | | | | |
| 12-15 | KLUCEL ™ E; 1 mol % | 17 | 30 | 1.8 | | Cellulosic thickener |
| | polyalkoxysilane | | | | | |
| 12-16 | KLUCEL ™ M (Hercules Inc.); | 46 | 22 | 0.5 | | Cellulosic thickener |
| | 10 mol % polyalkoxysilane | | | | | |
| 12-17 | LDO-97 (BASF) | 30 | 18 | 0.6 | | Polyethoxy polypropoxy |
| | | | | | | copolymer |
| 12-18 | LF-221 (Huntsman Chemicals) | 6 | 57 | 9.5 | yes | Alkylene polyethoxy |
| | | | | | | polyalkoxy ether |
| 12-19 | NPE-9.5 | 17 | 13 | 0.8 | | Alkylphenol ethoxylate |
| 12-20 | PLURONIC ™ 10R5 (BASF) | 8 | 14 | 1.8 | no | Reverse EO-PO copolymer |
| 12-21 | PLURONIC ™ 25R4 (BASF) | 29 | 9 | 0.3 | | Reverse EO-PO copolymer |
| 12-22 | PLURONIC ™ 31R1 (BASF) | 19 | 9 | 0.5 | | Reverse EO-PO copolymer |
| 12-23 | PLURONIC ™ L122 (BASF) | 5 | 13 | 2.6 | yes | EO-PO copolymer |
| 12-24 | PLURONIC ™ L62 (BASF) | 6 | 11 | 1.8 | | EO-PO copolymer |
| 12-25 | PLURONIC ™ P103 (BASF) | 9 | 11 | 1.2 | | EO-PO copolymer |
| 12-26 | Propylene glycol | 47 | 13 | 0.3 | | |
| 12-27 | TETRONIC ™ 50R8 (BASF) | 12 | 11 | 0.9 | | Reverse EO-PO copolymer of |
| | | | | | | ethylenediamine |
| 12-28 | TETRONIC ™ 704 (BASF) | 8 | 14 | 1.8 | | EO-PO copolymer of |
| | | | | | | ethylenediamine |
| 12-29 | TETRONIC ™ 904 (BASF) | 8 | 10 | 1.3 | | EO-PO copolymer |
| 12-30 | GLENSURF ™ 42/TYZOR ™ | 42 | 12 | 0.3 | | Propoxylated quat/2-propanol, |
| | TPT | | | | | titanium(4+) salt |
| 12-31 | VARIQUAT ™ 1215 (Witco | 18 | 27 | 1.5 | no | Ethoxylated quat |
| | Corporation) | | | | | |
| 12-32 | ZONYL ™ FSJ (duPont) | 13 | 52 | 4.0 | yes | Fluorinated ethoxylate |
| 12-33 | ZONYL ™ FSO (duPont) | 5 | 45 | 9.0 | yes | Fluorinated ethoxylate |
| 12-34 | 75% propylene glycol/25% | 14 | 18 | 1.3 | | PPG/EO-PO copolymer |
| | PLURONIC ™ L62 | | | | | |
| 12-35 | 50% propylene glycol/50% | 13 | 13 | 1.0 | no | PPG/EO-PO copolymer |
| | PLURONIC ™ L62 | | | | | |
| 12-36 | 25% propylene glycol/75% | 6 | 14 | 2.3 | | PPG/EO-PO copolymer |
| | PLURONIC ™ L62 | | | | | |
| 12-37 | 50% SURFONIC ™ 24-7 | 42 | 9 | 0.2 | no | linear ethoxylate/EO-PO |
| | (Huntsman Chemical)/50% | | | | | copolymer |
| | PLURONIC ™ L62 | | | | | |
| 12-38 | 50% PLURONIC ™ L62/50% | 24 | 11 | 0.5 | no | EO-PO copolymer/glycerol |
| | glycerol | | | | | |
| 12-39 | 50% LF221/50% | 35 | 13 | 0.4 | no | alkylene polyethoxy |
| | PLURONIC ™ L62 | | | | | polyalkoxy ether/EO-PO |
| | | | | | | copolymer |
| 12-40 | 50% LF221/50% LDO-97 | 13 | 15 | 1.2 | | Alkylene polyethoxy |
| | | | | | | polyalkoxy ether/polyethoxy |
| | | | | | | polypropoxy copolymer |
| 12-41 | 50% propylene glycol/50% | 59 | 20 | 0.3 | no | PPG/lauryl propylene diamine |
| | TOMAH ™ PA-1214 (Tomah | | | | | |
| | Products, Inc.) | | | | | |
| 12-42 | 50% LF221/50% TOMAH ™ | 74 | 22 | 0.3 | no | alkylene polyethoxy |
| | PA-1214 | | | | | polyalkoxy ether/lauryl |
| | | | | | | propylene diamine |
| 12-43 | 50% LF221/50% | 74 | 73 | 1.0 | no | Alkylene polyethoxy |
| | DYNASYLAN ™ F8800 | | | | | polyalkoxy ether/fluorinated |
| | (Degussa) | | | | | silane |
| Comp. Ex. 12-1 | Untreated control | 47 | 37 | 0.8 | | |
| Comp. Ex. 12-2 | Polyalkoxysilane control | 42 | 30 | 0.7 | no | Diethoxydimethylsilane |
| Comp. Ex. 12-3 | 3M ™ HC-259 | 82 | 51 | 0.6 | | |
| Comp. Ex. 12-4 | 3M ™ HC-759 | 48 | 53 | 1.1 | no | |
| Comp. Ex. 12-5 | ADSIL ™ AD00 (Adsil LC) | 84 | 44 | 0.5 | | Silane |
| Comp. Ex. 12-6 | ADSIL ™ AD110 (Adsil LC) | 89 | 45 | 0.5 | | Silane |
| Comp. Ex. 12-7 | ADSIL ™ AD150 (Adsil LC) | 76 | 46 | 0.6 | | Silane |
| Comp. Ex. 12-8 | ADSIL ™ AD20 (Adsil LC) | 76 | 46 | 0.6 | | Silane |
| Comp. Ex. 12-9 | ADSIL ™ AD209 (Adsil LC) | 73 | 23 | 0.3 | | Silane |
| Comp. Ex. 12-10 | ADSIL ™ AD30 (Adsil LC) | 67 | 39 | 0.6 | | Silane |
| Comp. Ex. 12-11 | ADSIL ™ AD310 (Adsil LC) | 76 | 15 | 0.2 | | Silane |
| Comp. Ex. 12-12 | ADSIL ™ AD35 (Adsil LC) | 89 | 13 | 0.1 | | Silane |
| Comp. Ex. 12-13 | ADSIL ™ AD360 (Adsil LC) | 82 | 36 | 0.4 | | Silane |
| Comp. Ex. 12-14 | ADSIL ™ AD65 (Adsil LC) | 86 | 39 | 0.5 | | Silane |
| Comp. Ex. 12-15 | AEGIS ™ AEM 5700 (Aegis | 57 | 17 | 0.3 | | |
| | Environments) | | | | | |
| Comp. Ex. 12-16 | CLEAN SHIELD ™ (Clean-X) | 90 | 25 | 0.3 | no | |
| Comp. Ex. 12-17 | DYNASYLAN ™ BH-N-P45 | 59 | 40 | 0.7 | | Fluorinated silane |
| | (Degussa) | | | | | |
| Comp. Ex. 12-18 | DYNASYLAN ™ F8261 | 44 | 40 | 0.9 | | Fluorinated silane |
| | (Degussa) | | | | | |
| Comp. Ex. 12-19 | DYNASYLAN ™ F8262 | 86 | 52 | 0.6 | | Fluorinated silane |
| | (Degussa) | | | | | |
| Comp. Ex. 12-20 | DYNASYLAN ™ F8263 | 75 | 73 | 1.0 | | Fluorinated silane |
| | (Degussa) | | | | | |
| Comp. Ex. 12-21 | DYNASYLAN ™ F8800 | 84 | 63 | 0.75 | no | Fluorinated silane |
| | (Degussa) | | | | | |
| Comp. Ex. 12-22 | HYDRO HYSPEED KOTE ™ | 63 | 21 | 0.3 | | |
| | (Marine Polymer Group, Inc.) | | | | | |
| Comp. Ex. 12-23 | HYDROSYL ™ 2759 | 71 | 29 | 0.4 | | Aqueous solution of |
| | (Degussa) | | | | | epoxy/glycol-silane |
| Comp. Ex. 12-24 | Quick Craft ™ (No Limits | 11 | 43 | 3.9 | yes | Polymer |
| | Racing) | | | | | |
| Comp. Ex. 12-25 | Rain-X ™ Glass Treatment | 88 | 36 | 0.4 | no | |
| | (Blue Coral-Slick 50, Ltd.) | | | | | |

The results in Table 12 illustrate a variety of surface treatment compositions of the invention. Compositions that provided an oil contact angle/water contact angle ratio of 2.3 or more were especially effective. Variation in the HLB ratio of the hydroxyether (e.g., as shown in Example Nos. 12-1 through 12-7) did not significantly alter the oil contact angle/water contact angle ratio. Blending of propylene oxide with a linear ethylene oxide-propylene oxide copolymer (e.g., as shown in Example Nos. 12-34 through 12-36) tended to increase the oil contact angle/water contact angle ratio as the proportion of propylene glycol decreased.

Most of the comparison formulations provided an oil contact angle/water content angle ratio at or below 1. The Quick Craft™ coating gave an oil contact angle/water contact angle ratio of 3.9, but the coating was a polymer that required over four hours drying time.

### EXAMPLE 13

A composition of the invention (e.g., the treatment of Example No. 11) could be applied to the fiberglass hull of a 5 meter RANGER™ boat and allowed to dry. The hull treatment should provide improved speed and handling, increased resistance to scum, dirt and algae accumulation, and should aid in discouraging transmission of unwanted plants (e.g., Eurasian watermilfoil, Myriophyllum spicatum) or other organisms when the boat is trailered from lake to lake.

Various modifications and alterations of this invention will be apparent to those skilled in the art without departing from the scope and spirit of the invention, and are intended to be within the scope of the following claims.

1. A surface treatment composition comprising a mixture of hydroxyether and polyalkoxysilane.

2. A composition according to claim 1 comprising a surface-reactive, alkoxy-containing adduct of hydroxyether and dialkoxy- or trialkoxysilane.

3. A composition according to claim 1 wherein the hydroxyether has the formula:
AY_{X}
where:
A is hydrogen or a C₁-C₂₄ linear or branched, saturated or unsaturated alkyl, aralkyl, or aryl group that may contain O, N, S, or P heteroatoms or halogen atoms,
Y is —[(OCH₂CH₂)ₘ(O(R₆)CHCH₂)ₙOH] where m and n are not both zero and independently may be 0 to 100,000; R₆ can be hydrogen or a C₁-C₂₄ alkyl group; and Y may contain halogen (e.g., fluorine) atoms.
X is a number from 1 to 4.

4. A composition according to claim 1 wherein the hydroxyether comprises a salt.

5. A composition according to claim 1 wherein the hydroxyether comprises a polyoxyethylene, polyoxypropylene, ethylene oxide/alkylene oxide copolymer, alkyl glycol ether, alcohol ethoxylate, alcohol propoxylate, alcohol ethoxylate-propoxylate; alkylphenol ethoxylate, alkylphenol propoxylate, alkylphenol ethoxylate-propoxylate, mixture or salt thereof.

6. A composition according to claim 1 wherein the polyalkoxysilane has the formulae: 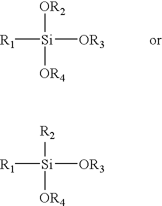
where:
R₁ is a C₁-C₂₄ linear or branched, saturated or unsaturated alkyl, aralkyl, or aryl group that may contain O, N, S, or P heteroatoms or halogen atoms,
R₂, R₃, and R₄ can be independently selected from C₁-C₂₄ linear or branched, saturated or unsaturated alkyl, aralkyl, or aryl groups.

7. A composition according to claim 1 wherein the polyalkoxysilane comprises a trialkoxysilane.

8. A composition according to claim 1 wherein the polyalkoxysilane comprises a dialkoxysilane.

9. A composition according to claim 1 wherein the polyalkoxysilane comprises diethoxydimethylsilane.

10. A composition according to claim 1 wherein the polyalkoxysilane comprises octyltriethoxysilane, vinyldimethoxysilane, isobutyltrimethoxysilane, 3-aminopropyltriethoxysilane, 3-methyacryloxypropyltrimethoxysilane, methylaminopropyltrimethoxysilane, 3-glycidoxypropyltrimethoxysilane, cyclohexylmethyldimethoxysilane, diphenyldimethoxysilane, isobutylisopropyldimethoxysilane, hexadecyldiethoxysilane, 3-mercaptopropyltrimethoxysilane or a mixture thereof.

11. A composition according to claim 1 wherein the hydroxyether and polyalkoxysilane are mixed in a molar ratio between about 1/20 and about 20/1.

12. A composition according to claim 1 wherein the hydroxyether and polyalkoxysilane are mixed in a molar ratio between about 1/5 and about 5/1.

13. A composition according to claim 1 wherein the hydroxyether and polyalkoxysilane are mixed in a molar ratio between about 1/2 and about 2/1.

14. A kit comprising a surface treatment composition according to claim 1, a detergent for cleaning the surface, an applicator for applying the composition to a surface, a removal agent for restoring a surface to its original untreated condition, and instructions for use of the kit.

15. A method for treating a surface comprising applying thereto a mixture of hydroxyether and polyalkoxysilane and allowing the surface to dry.

16. A method according to claim 15 wherein the mixture comprises a surface-reactive, alkoxy-containing adduct of hydroxyether and dialkoxy- or trialkoxysilane and the surface to be treated has a plurality of available hydroxyl, amine or amide groups.

17. A method according to claim 15 further comprising the step of mixing the hydroxyalkylether and polyalkoxysilane before applying the mixture to the surface.

18. A method according to claim 17 wherein the mixture is allowed to stand for a time sufficient to permit hydrolysis of at least one of the alkoxy groups on the polyalkoxysilane to take place.

19. A method according to claim 15 wherein the hydroxyether has the formula:
AY_{X}
where:
A is hydrogen or a C₁-C₂₄ linear or branched, saturated or unsaturated alkyl, aralkyl, or aryl group that may contain O, N, S, or P heteroatoms or halogen atoms,
Y is —[(OCH₂CH₂)ₘ(O(R₆)CHCH₂)ₙOH] where m and n are not both zero and independently may be 0 to 100,000; R₆ can be hydrogen or a C₁-C₂₄ alkyl group; and Y may contain halogen (e.g., fluorine) atoms.
X is a number from 1 to 4.

20. A method according to claim 15 wherein the hydroxyether comprises a salt.

21. A method according to claim 15 wherein the hydroxyether comprises a polyoxyethylene, polyoxypropylene, ethylene oxide/alkylene oxide copolymer, alkyl glycol ether, alcohol ethoxylate, alcohol propoxylate, alcohol ethoxylate-propoxylate; alkylphenol ethoxylate, alkylphenol propoxylate, alkylphenol ethoxylate-propoxylate, mixture or salt thereof.

22. A method according to claim 15 wherein the polyalkoxysilane has the formulae: 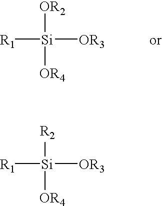
where:
R₁ is a C₁-C₂₄ linear or branched, saturated or unsaturated alkyl, aralkyl, or aryl group that may contain O, N, S, or P heteroatoms or halogen atoms,
R₂, R₃, and R₄ can be independently selected from C₁-C₂₄ linear or branched, saturated or unsaturated alkyl, aralkyl, or aryl groups.

23. A method according to claim 15 wherein the polyalkoxysilane comprises a trialkoxysilane.

24. A method according to claim 15 wherein the polyalkoxysilane comprises a dialkoxysilane.

25. A method according to claim 15 wherein the polyalkoxysilane comprises diethoxydimethylsilane.

26. A method according to claim 15 wherein the polyalkoxysilane comprises octyltriethoxysilane, vinyldimethoxysilane, isobutyltrimethoxysilane, 3-aminopropyltriethoxysilane, 3-methyacryloxypropyltrimethoxysilane, methylaminopropyltrimethoxysilane, 3-glycidoxypropyltrimethoxysilane, cyclohexylmethyldimethoxysilane, diphenyldimethoxysilane, isobutylisopropyldimethoxysilane, hexadecyldiethoxysilane, 3-mercaptopropyltrimethoxysilane or a mixture thereof.

27. A method according to claim 15 wherein the hydroxyether and polyalkoxysilane are mixed in a molar ratio between about 1/20 and about 20/1.

28. A method according to claim 15 wherein the hydroxyether and polyalkoxysilane are mixed in a molar ratio between about 1/5 and about 5/1.

29. A method according to claim 15 wherein the hydroxyether and polyalkoxysilane are mixed in a molar ratio between about 1/2 and about 2/1.

30. A method according to claim 15 wherein the polyalkoxysilane is added to the hydroxyether.

31. A method according to claim 15 wherein the treatment reduces both the oil and water contact angles exhibited by the surface.

32. A method according to claim 15 wherein the treatment reduces the oil contact angle and increases the water contact angle exhibited by the surface.

33. A method according to claim 15 wherein the treatment increases both the oil and water contact angles exhibited by the surface.

34. A method according to claim 15 wherein the treatment increases the oil contact angle and reduces the water contact angle exhibited by the surface.

35. A method according to claim 15 wherein the ratio of oil contact angle to water contact angle for the treated surface is at least 0.8.

36. A method according to claim 15 wherein the ratio of oil contact angle to water contact angle for the treated surface is at least 1.

37. A method according to claim 15 wherein the ratio of oil contact angle to water contact angle for the treated surface is at least 2.3.

38. A method according to claim 15 wherein water tends to form a sheet on the treated surface, oil tends to form beads on the treated surface, and the water sheet tends to ride underneath and lift away the oil beads.

39. A method according to claim 15 wherein the surface comprises glass, fiberglass, ceramic tile, concrete, natural stone, masonry, gypsum, metal, cotton, paper, aluminum, paint or a polymer.

40. A soil-releasing treated surface having bound thereto an adduct of hydroxyether and polyalkoxysilane.

41. A treated surface according to claim 40 wherein the adduct reduces both the oil and water contact angles exhibited by the surface if untreated.

42. A treated surface according to claim 40 wherein the adduct reduces the oil contact angle and increases the water contact angle exhibited by the surface if untreated.

43. A treated surface according to claim 40 wherein the adduct increases both the oil and water contact angles exhibited by the surface if untreated.

44. A treated surface according to claim 40 wherein the adduct treatment increases the oil contact angle and reduces the water contact angle exhibited by the surface if untreated.

45. A treated surface according to claim 40 wherein the ratio of oil contact angle to water contact angle for the treated surface is at least 0.8.

46. A treated surface according to claim 40 wherein the ratio of oil contact angle to water contact angle for the treated surface is at least 1.

47. A treated surface according to claim 40 wherein the ratio of oil contact angle to water contact angle for the treated surface is at least 2.3.

48. A treated surface according to claim 40 wherein water tends to form a sheet on the treated surface, oil tends to form beads on the treated surface, and the water sheet tends to ride underneath and lift away the oil beads.

49. A treated surface according to claim 40 wherein the surface comprises glass, fiberglass, ceramic tile, concrete, natural stone, masonry, gypsum, metal, cotton, paper, aluminum, paint or a polymer.

50. A treated surface according to claim 40 comprising an architectural surface, fabric, transportation vehicle, food or beverage process equipment or water handling system.

51. A treated surface according to claim 40 comprising a shower stall.

52. A treated surface according to claim 40 wherein the adduct makes the surface easier to clean.

53. A treated surface according to claim 40 wherein the adduct makes it possible to clean the surface using milder or safer cleaning agents.

54. A treated surface according to claim 40 wherein the adduct makes cleanliness of the surface easier to maintain.
